(19) United States
(12) Patent Application Publication
(10) Pub. No.: US 2024/0409248 A1
(43) Pub. Date: Dec. 12, 2024

(54) POWER DISTRIBUTION FOR AIRCRAFT

(71) Applicant: Performance Drone Works LLC, Huntsville, AL (US)

(72) Inventors: Philip Herlihy, Mahopac, NY (US); William Edward Abell, Meridianville, AL (US); Jarred Lee Beck, Huntsville, AL (US)

(73) Assignee: Performance Drone Works LLC, Huntsville, AL (US)

(21) Appl. No.: 18/512,424

(22) Filed: Nov. 17, 2023

Related U.S. Application Data
(60) Provisional application No. 63/506,577, filed on Jun. 6, 2023.

(51) Int. Cl. B64U 50/30; B64D 27/24

(52) U.S. Cl. CPC B64U 50/30; B64D 27/24; B64D 2221/00

(57) ABSTRACT

An aircraft comprises an aircraft body, multiple battery packs positioned on the aircraft body, a load balancing circuit positioned on the aircraft body and connected to a battery power node, multiple motors positioned on the aircraft body and connected to the battery power node, and multiple bypass circuits positioned on the aircraft body. The load balancing circuit comprises multiple current delivery circuits. Each current delivery circuit is connected between one of the battery packs and the battery power node. Each of the bypass circuits is connected to the battery power node and one of the battery packs to provide a signal path from the battery power node to the respective battery pack that bypasses a respective current delivery circuit for regenerative current from one or more of the motors.

This application claims the benefit from U.S. Provisional Application 63/506,577, filed on Jun. 6, 2023, incorporated herein by reference in its entirety.

### BACKGROUND OF THE INVENTION

Radio controlled unmanned aerial vehicles (“UAVs), also known as drones, can move at high speed and make rapid changes in direction when remotely piloted by a skilled user. One example of a UAV is a quadcopter. A drone may include a flight controller that provides output to motors and thus controls propeller speed to change thrust (e.g., in response to commands received from a user via a communication channel such as a Radio Frequency (RF) communication channel established between a user's remote-control and a drone). For example, a quadcopter has four motors, each coupled to a corresponding propeller above the motor, with propellers mounted to generate thrust substantially in parallel (e.g., their axes of rotation may be substantially parallel). The flight controller may change the speeds of the motors to change the orientation and velocity of the drone and the propellers may remain in a fixed orientation with respect to the chassis (body) of the quadcopter (i.e. without changing the angle of thrust with respect to the quadcopter) and may have fixed-pitch (i.e. propeller pitch may not be adjustable like a helicopter propeller so that each motor powers a corresponding fixed-pitch propeller in a fixed orientation with respect to a drone chassis).

When the speed of the motors change quickly or abruptly, the motors may generate regenerative current. This regenerative current can be used to recharge the UAV's onboard batteries. However, if not handled properly, the regenerative current can damage some of the components of the UAV.

### BRIEF DESCRIPTION OF DRAWINGS

Like-numbered elements refer to common components in the different figures.

FIG. 1 is a block diagram depicting one embodiment of an aircraft.

FIG. 2 is a block diagram of one embodiment of a power distribution system for an aircraft.

FIG. 3 is a block diagram of one embodiment of a battery pack.

FIG. 4 is a block diagram of one embodiment of a bypass circuit.

FIG. 5 is a flow chart describing one embodiment of a process for operating an aircraft.

FIG. 6 is a flow chart describing one embodiment of a process for providing a signal path for regenerative current from one or more motors to one or more batteries.

### DETAILED DESCRIPTION

A UAV is proposed that includes a power system that load balances during standard operation, and safely receives regenerative current from the motors during a regenerative event (e.g., the motors quickly slowing down, coming to an abrupt stop, or reversing direction). One embodiment of the UAV comprises an aircraft body with multiple battery packs positioned on the aircraft body, a load balancing circuit positioned on the aircraft body and connected to a battery power node, multiple motors positioned on the aircraft body and connected to the battery power node, and multiple bypass circuits positioned on the aircraft body and connected to the battery power node. The load balancing circuit comprises multiple current delivery circuits. Each current delivery circuit is connected between one of the battery packs and a battery power node. Each of the multiple bypass circuits is connected to the battery power node and one of the battery packs to provide a signal path from the battery power node to the respective battery pack that bypasses a respective current delivery circuit for regenerative current from one or more of the motors. The technology described herein can also be used with other types of aircraft in addition to UAVs.

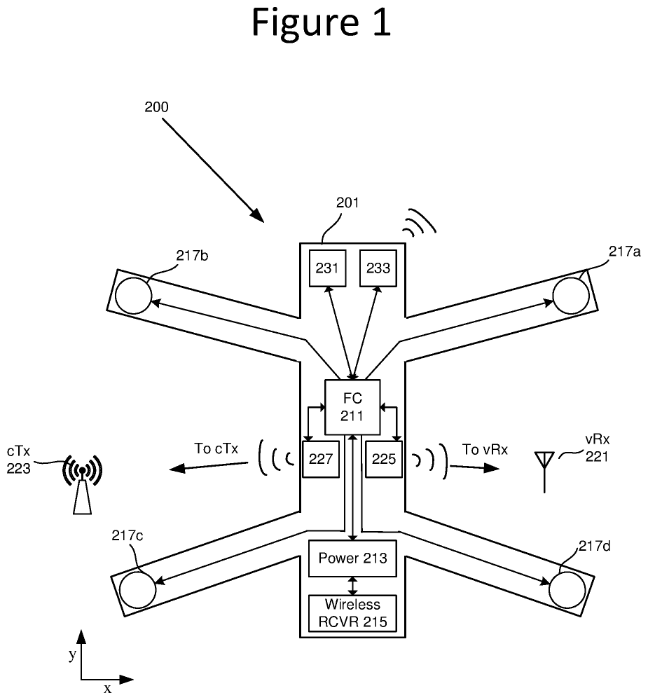

FIG. 1 is simplified representation of some of the components for one example of a UAV 200, which is a remote-controlled quadcopter in this example. FIG. 1 shows UAV (or aircraft) 200 comprising an aircraft body 201 and multiple components positioned on the aircraft body 201, including flight controller 211 connected to motors 217a-d (which turn respective propellers, not depicted in FIG. 1), power distribution system 213, wireless receiver 215, video camera 231, altitude sensor 233, and transmitters 225 and 227. In this embodiment, extending on an arm from each of the corners of UAV 200 is one of the motors 217a-d, each of which is controlled by the flight controller 211 to thereby control thrust generated by propellers attached to motors 217a-d. Power distribution system 213 supplies power to flight controller 211 and the other flight electronics (e.g., sensors, receives, transmitters, cameras, processors, etc.). A pilot's commands are transmitted from control signal transceivers such as cTx 223, received by wireless receiver 215. Control signal transceiver cTx 223 may be in a remote-control operated by a pilot (remote-control user) to fly UAV 200. The flight controller 211 uses power from power distribution system 213 to drive the motors 217a-d according to the pilot's signals. In one embodiment, flight controller 211 includes one or more processors programmed (configured) by software to perform the functions discussed herein. In another embodiment, flight controller 211 is a hardwired circuit (with no software) that is configured to perform the functions discussed herein.

UAV 200 also includes video camera 231 and altitude sensor 233 that supply data to the flight controller 211. An FM or other type video transmitter 225 transmits data from the video camera 231 to a video monitor receiver vRx 221 (external to the UAV, such as on the ground) that monitors the video signals and passes on the video data to the pilot. Data can also be sent back to the control signal transceiver cTx 223 by the transmitter 227. Although the transmitter 227 and wireless receiver 215 are shown as separate elements in FIG. 1, in many embodiments these will be part of a single transceiver module. Additionally, control signal transceiver cTx 223 and video monitor receiver vRx 221 may be part of a single transceiver module. For example, a remote-control may include both a control signal transceiver and a video monitor receiver to allow a remote-control user to see video from video camera 231 while piloting UAV 200.

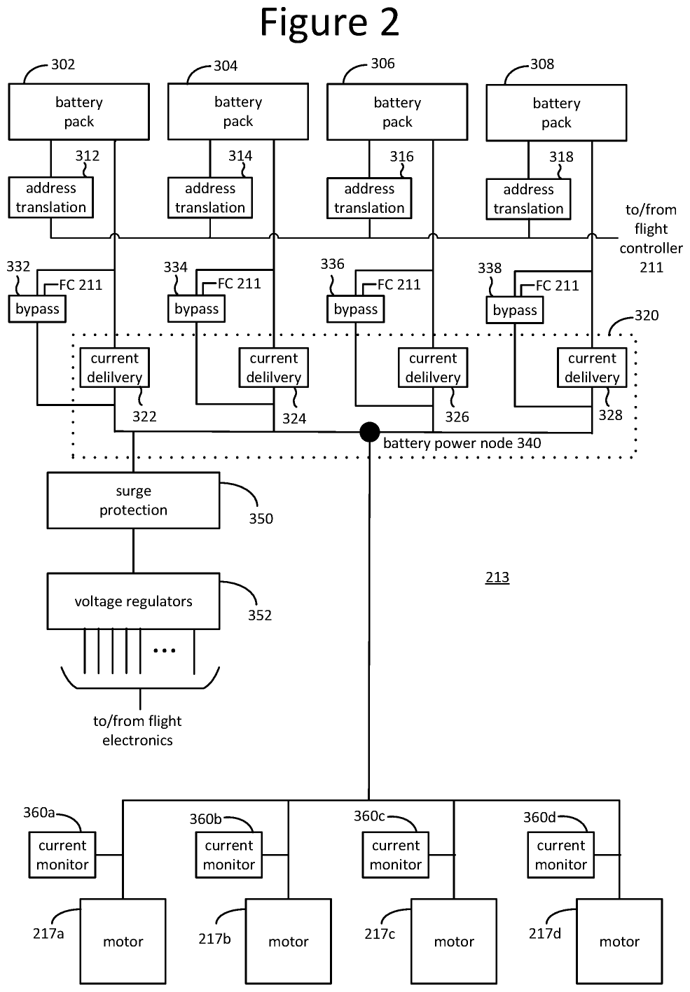

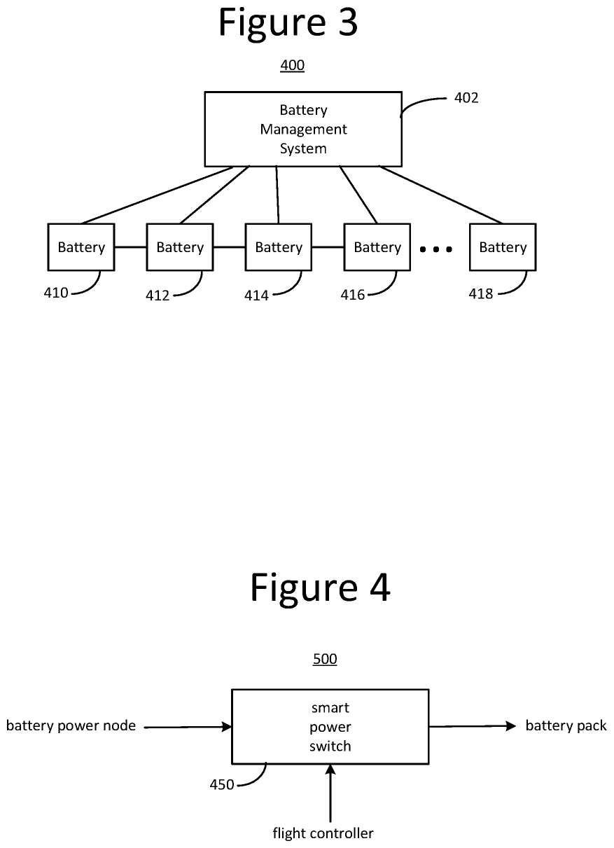

FIG. 2 is a block diagram of one embodiment of a power distribution system 213 for a UAV or other type of aircraft. Power distribution system 213 includes multiple battery packs. In one embodiment, power distribution system 213 includes four battery packs 302, 304, 306 and 308. In other embodiments, more or less than four battery packs can be used. Each of the battery packs include multiple rechargeable batteries connected in series and connected to a battery management system. For example, FIG. 3 depicts one embodiment of a battery pack 400 comprising batteries 410, 412, 414, 416, . . . 418 connected in series. In one embodiment, a battery pack incudes twelve batteries connected in series; however, a different number of batteries can also be used. Each of batteries 410, 412, 414, 416, . . . 418 are connected to a battery management system 402. In one embodiment, battery management system 402 includes one or more processors programmed by software to manage the connected batteries 410, 412, 414, 416, . . . 418, including sensing/determining battery health data about batteries 410, 412, 414, 416, . . . 418; load balancing among batteries 410, 412, 414, 416, . . . 418; managing the cooling or heating of the batteries to maintain battery health; etc. Examples of battery health data that battery management system 402 maintains for each of batteries 410, 412, 414, 416, . . . 418 (and for the battery pack as a whole) includes status state of charge, age, capacity, temperature, etc. Battery management system 402 communicates with flight controller 211 (as discussed below) to report the above-described battery health data and to receive commands from flight controller 211 (e.g., to turn off or on the battery pack). Battery pack 400 can be used to implement each of battery packs 302, 304, 306 and 308.

Looking back at FIG. 2, each of battery packs 302, 304, 306 and 308 are connected to an address translation circuit. For example, battery pack 302 is connected to address translation circuit 312, battery pack 304 is connected to address translation circuit 314, battery pack 306 is connected to address translation circuit 316, and battery pack 308 is connected to address translation circuit 318. Each of address translation circuits 312, 314, 316 and 318 are connected to and bidirectionally communicate with flight controller 211. Flight controller 211 sends commands to the battery management systems of battery packs 302, 304, 306 and 308 via the respective connected address translation circuits 312, 314, 316 and 318. The battery management systems of battery packs 302, 304, 306 and 308 send battery health data (including status) about the battery packs to flight controller 211 via the respective connected address translation circuits 312, 314, 316 and 318.

In one embodiment, flight controller 211 assigns each battery pack a different address. However, each of the battery packs are designed to respond to the same common address, which enables battery packs to be easily swapped in and out of the system. To make this arrangement work, the address translation circuits 312, 314, 316 and 318 translate between the different addresses assigned to each battery pack by flight controller 211 and the common address that all of the battery packs respond to. In this manner, each address translation circuit is configured to use the same address to communicate with its respective connected battery pack, flight controller 211 is configured to uses different addresses to communicate with different address translation circuits, the address translation circuits receive battery health data from respective connected battery packs and the address translation circuits forward that battery health data to the flight controller while performing the address translation. In one embodiment, each of the address translation circuits 312, 314, 316 and 318 include a LTC4316 Single I²C/SMBus Address Translator from Analog Devices.

Power distribution system 213 includes a load balancing circuit 320 that is configured to distribute and/or balance the use of the battery packs 302, 304, 306 and 308. In one embodiment, load balancing circuit 320 is configured to draw power from the battery pack with the highest state of charge. When multiple battery packs have the same state of charge (or within a predetermined delta of the same state of charge) and highest state of charge, then load balancing circuit 320 will draw power from the multiple battery packs have the same and highest state of charge. Therefore, in this embodiment, load balancing circuit 320 is configured to draw power from the battery pack with the highest state of charge until that battery pack's state of charge is lowered to be the same (or close to the same) as another battery pack so that more than one battery has a highest state of charge, and when more than one battery pack has a highest state of charge then the load balancing circuit is configured to draw power from the more than one battery pack with the highest state of charge. In one embodiment, state of charge is reported as a number between 0 and 100%, representing how much charge is remaining in the battery pack. In one embodiment, the voltage output of a battery pack is indicative of state of charge.

One embodiment of load balancing circuit 320 includes current delivery circuit 322, current delivery circuit 324, current delivery circuit 326, and current delivery circuit 328. The input of each of the delivery circuits 322/324/326/328 is from respective connected battery packs and the outputs of each of the current delivery circuits 322/324/326/328 are connected together at battery power node 340. Each of battery packs 302, 304, 306 and 308 provide a power signal output. For example, battery pack 302 is connected to and provides a power signal to current delivery circuit 322, battery pack 304 is connected to and provides a power signal to current delivery circuit 324, battery pack 306 is connected to and provides a power signal to current delivery circuit 326, and battery pack 308 is connected to and provides a power signal to current delivery circuit 328.

In one embodiment, the voltage output at battery power node 340 is approximately the same as the highest voltage input to battery power node 340. For example, the highest voltage among the output of current delivery circuit 322, the output of current delivery circuit 324, the output of current delivery circuit 326, and the output of current delivery circuit 328 is provided as the output voltage at battery power node 340.

In one embodiment, each of current delivery circuit 322, current delivery circuit 324, current delivery circuit 326, and current delivery circuit 328 comprise, or is implemented by a Schottky diode.

In one embodiment, each of current delivery circuit 322, current delivery circuit 324, current delivery circuit 326, and current delivery circuit 328 will only draw power from their respective connected battery and pass it to the battery power node 340 if the input to the current delivery circuit (i.e., the power signal output of the connected battery pack) is the same voltage magnitude or a higher voltage magnitude than the voltage at battery power node 340.

In one embodiment, each of current delivery circuit 322, current delivery circuit 324, current delivery circuit 326, and current delivery circuit 328 is implemented by LTC4372 Low Quiescent Current Ideal Diode Controller from Analog Devices, driving an external N-channel MOSFET. In one example implementation, flight controller 211 is connected to each of current delivery circuit 322, current delivery circuit 324, current delivery circuit 326, and current delivery circuit 328 in order to enable or disable each current delivery circuit.

Battery power node 340 provides power to various components of the UAV. For example, each of motors 217a-d are connected to battery power node 340 to receive power. Each of motors 217a-d are connected to and controlled by flight controller 211. Connected to an input of each motor 217a-d is a respective current monitor circuit 360a, 360b, 360c and 360d. Each of current monitor circuits 360a, 360b, 360c and 360d monitor the current in and out of their respective connected motors and report that monitored current to flight controller 211. Additionally, other flight electronics (e.g., sensors, receives, transmitters, cameras, processors, etc.) receive power a set of voltage regulators 352 connected to battery power node 340 via surge protection circuit 350.

Motors 217a-d are configured to create regenerative current in response to a regenerative event (e.g., the motors quickly slowing down, performing a braking action, coming to an abrupt stop, or reversing direction). The regenerative current from all of the motors is dumped into the battery power node 340, and then back to the battery packs in order to recharge the batteries. It is possible that the regeneration current is a high current in conjunction with a high voltage that can damage current delivery circuits 322, 324, 326 and 328 as well as voltage regulators 352. In order to protect current delivery circuits 322, 324, 326 and 328 from a high current and/or high voltage of the regeneration current, power distribution system 213 includes a set of bypass circuits 332, 334, 336 and 338. In order to protect voltage regulators 352 from a high current and/or high voltage of the regeneration current, power distribution system 213 includes surge protection circuit 350.

Bypass circuits 322, 324, 326 and 328 are each connected to the battery power node 340 and one of the battery packs to provide a signal path from the battery power node 340 to the respective battery pack that bypasses a respective current delivery circuit for regenerative current from one or more of the motors. For example, bypass circuit 332 is connected to battery power node 340 at its input and to battery pack 302 at its output; bypass circuit 334 is connected to battery power node 340 at its input and to battery pack 304 at its output; bypass circuit 336 is connected to battery power node 340 at its input and to battery pack 306 at its output; and bypass circuit 338 is connected to battery power node 340 at its input and to battery pack 308 at its output. Bypass circuit 332 provides a signal path from the battery power node 340 to battery pack 302 that bypasses current delivery circuit 322 for regenerative current from one or more of the motors 2127a-d. Bypass circuit 334 provides a signal path from the battery power node 340 to battery pack 304 that bypasses current delivery circuit 324 for regenerative current from one or more of the motors 2127a-d. Bypass circuit 336 provides a signal path from the battery power node 340 to battery pack 306 that bypasses current delivery circuit 326 for regenerative current from one or more of the motors 2127a-d. Bypass circuit 338 provides a signal path from the battery power node 340 to battery pack 308 that bypasses current delivery circuit 322 for regenerative current from one or more of the motors 2127a-d.

In one embodiment each of the bypass circuits 332, 334, 336 and 338 are connected to and receive an input from flight controller 211 (FC 211). When there is no regenerative event, flight controller 211 instructs each of bypass circuits 332, 334, 336 and 338 to be “off” such that the bypass circuits are not providing a signal path from the battery power node 340 to the respective battery pack that bypasses a respective current delivery circuit for regenerative current from one or more of the motors. When there is a regenerative event, flight controller 211 instructs each of bypass circuits 332, 334, 336 and 338 to be “on” such that the bypass circuits are providing a signal path from the battery power node 340 to the respective battery pack that bypasses a respective current delivery circuit for regenerative current from one or more of the motors. In this manner, the flight controller 211 is configured to turn on the bypass circuits 332, 334, 336 and 338 when the motors 217a-d are providing regenerative current and turn off the bypass circuits when the motors 217a-d are not providing regenerative current. In other words, the flight controller is configured to determine that a regenerative event is occurring and turn on the multiple bypass circuits in response to determining that the regenerative event is occurring.

In one embodiment, the bypass circuits 332, 334, 336 and 338 are configured to dump regenerative current from one or more of the motors 217a-d into all or a subset of battery packs such that even a battery pack not currently being used by the load balancing circuit 320 to power the aircraft will receive the regenerative current.

In one embodiment, each of the bypass circuits 332, 334, 336 and 338 include a switch that can be opened and closed in response to an indication from flight controller 211 whether a regenerative event is occurring. FIG. 4 is a block diagram of one embodiment of a bypass circuit 500. In one embodiment, bypass circuit 500 includes a smart power switch 450. One example of a smart power switch is a PROFET BTS 6163D Smart Highside Power Switch from Infineon Technologies AG. Other switches can also be used. Bypass circuit 500 can be used to implement each of bypass circuits 332, 334, 336 and 338.

Surge protection circuit 350 protects voltage regulators 352 from the high current and/or high voltage of a regeneration current. Surge protection circuit 350 has an input connected to the battery power node 340 and an output connected to the voltage regulator 352. In one embodiment, surge protection circuit 350 includes a switch (e.g., transistor) and the surge protection circuit 350 is configured to automatically reduce effective voltage of the regenerative current from one or more of the motors 217a-d by opening and closing the switch multiple times, at a high rate, during the regenerative current. In one embodiment, surge protection circuit 350 is implemented with a LTC7860 High Efficiency Switching Surge Stopper from Linear Technologies. During an input overvoltage event, such as a load dump during a regenerative event in a UAV, the LTC7860 controls the gate of an external MOSFET to act as a switching DC/DC regulator. This operation regulates the output voltage to a safe level, allowing the loads to operate through the input over-voltage event. During normal operation, the LTC7860 turns on the external MOSFET.

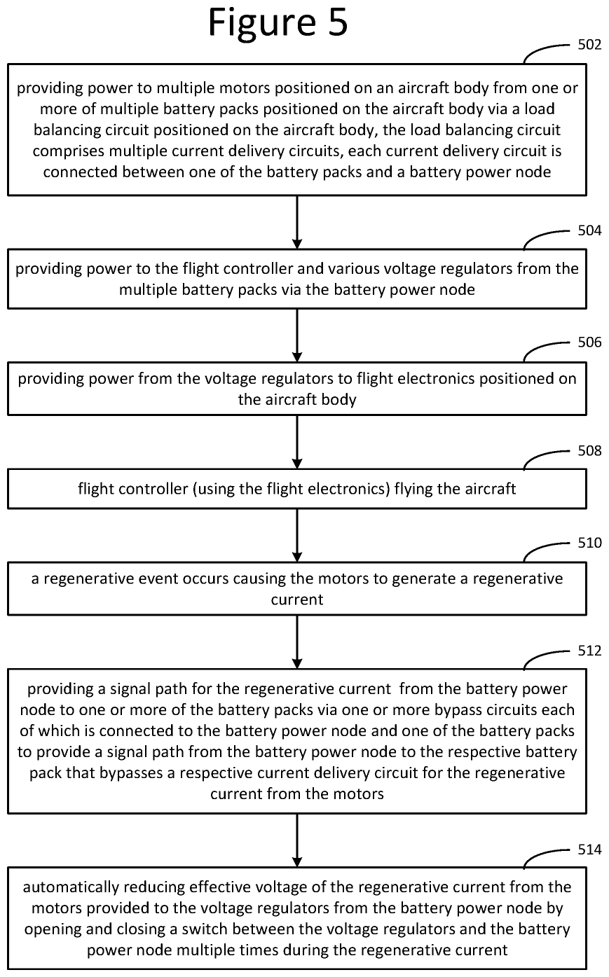

FIG. 5 is a flow chart describing one embodiment of a process for operating an aircraft, including operating power distribution system 213. In step 502, power distribution system 213 provides power to multiple motors 217a-d positioned on the aircraft body 201 from one or more of multiple battery packs 302, 304, 306, 308 positioned on the aircraft body 201 via the load balancing circuit 320 positioned on the aircraft body 201. The load balancing circuit 320 comprises multiple current delivery circuits 322/324/326/328, such that each current delivery circuit is connected between one of the battery packs and a battery power node 340 (as depicted in FIG. 2). In step 504, power distribution system 213 provides power to the flight controller 211 and various voltage regulators 352 from one or more of the multiple battery packs 302/304/306/308 via the battery power node 340. In step 506, power distribution system 213 provides power from the voltage regulators 352 to flight electronics positioned on the aircraft body 201 (see e.g., FIG. 1). In step 508, flight controller 211 (using the flight electronics) flies the aircraft. In one embodiment, a pilot using a remote controller operates the aircraft by sending commands to flight controller 211.

In step 510, a regenerative event occurs causing the motors to generate regenerative current. For example, motors 217a-d are abruptly slowed down, stopped or reversed. In step 512, power distribution system 213 provides a signal path for the regenerative current from the battery power node 340 to one or more of the battery packs 302/304/306/308 via one or more bypass circuits 332/334/336/338, each of which is connected to the battery power node 340 and one of the battery packs 302/304/306/308 to provide a signal path from the battery power node to the respective battery pack that bypasses a respective current delivery circuit (e.g., of current delivery circuits 322/324/326/328) for the regenerative current from the motors 217a-d. In step 514, surge protection circuit 350 automatically reduces the effective voltage of the regenerative current from the motors 217a-d provided to the voltage regulators 352 from the battery power node 340 by opening and closing a switch between the voltage regulators 352 and the battery power node 340 multiple times and at a high speed during the regenerative current.

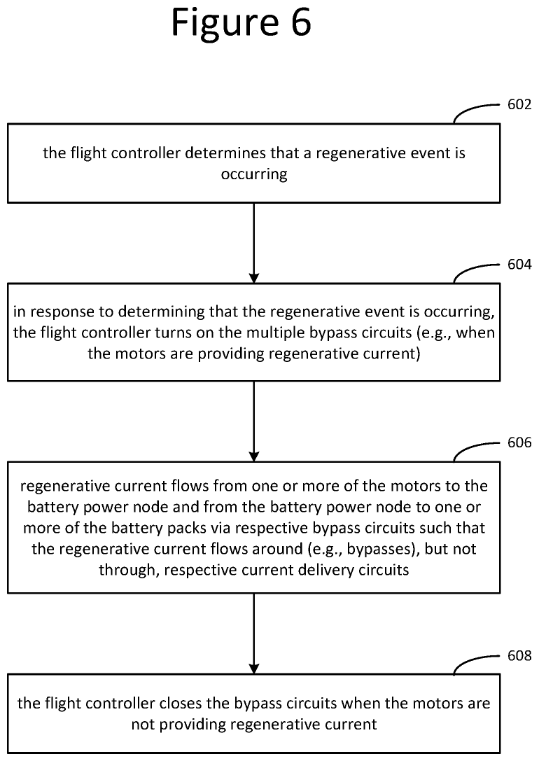

FIG. 6 is a flow chart describing one embodiment of a process for providing a signal path for regenerative current from one or more motors to one or more batteries. Thus, the process of FIG. 6 is an example implementation of step 512 of FIG. 5. In step 602, flight controller 211 determines that a regenerative event is occurring. In step 604, in response to determining that the regenerative event is occurring (e.g., when the motors are providing regenerative current), flight controller 213 turns on or more of the bypass circuits 332, 334, 336 and/or 338. In step 606, regenerative current flows from one or more of the motors to the battery power node and from the battery power node to one or more of the battery packs via respective bypass circuits such that the regenerative current flows around (e.g., bypasses), but not through, respective current delivery circuits. In step 608, flight controller 211 closes the bypass circuits 332, 334, 336 and/or 338 when the motors are not providing regenerative current.

An aircraft is proposed that includes a power system that load balances and safely receives regenerative current from the motors during a regenerative event (e.g., the motors quickly slowing down, coming to an abrupt stop, or reversing direction).

One embodiment of the aircraft comprises an aircraft body multiple battery packs positioned on the aircraft body a load balancing circuit positioned on the aircraft body, multiple motors positioned on the aircraft body and connected to a battery power node, and multiple bypass circuits positioned on the aircraft body. The load balancing circuit comprises multiple current delivery circuits, and each current delivery circuit is connected between one of the battery packs and a battery power node. Each of the multiple bypass circuits is connected to the battery power node and one of the battery packs to provide a signal path from the battery power node to the respective battery pack that bypasses a respective current delivery circuit for regenerative current from one or more of the motors.

One example implementation further comprises a flight controller positioned on the aircraft body and connected to the bypass circuits, the flight controller is configured to turn on the bypass circuits when the motors are providing regenerative current and turn off the bypass circuits when the motors are not providing regenerative current.

In one example implementation, each battery pack includes multiple batteries in series and a battery management system.

One example implementation further comprises address translation circuits each of which is connected to one of the battery packs, each address translation circuit uses the same address to communicate with its respective connected battery pack; and a flight controller connected to the address translation circuits, the flight controller uses different addresses to communicate with different address translation circuits, the address translation circuits receive battery health data from respective connected battery packs and forward that battery health data to the flight controller.

In one example implementation, the multiple battery packs include a first battery pack and a second battery pack; the load balancing circuit comprises a first current delivery circuit and a second current delivery circuit; the first current delivery circuit has an input connected to the first battery pack and an output connected to the battery power node; the second current delivery circuit has an input connected to the second battery pack and an output connected to the battery power node; the multiple bypass circuits comprise a first bypass circuit and a second bypass circuit; the first bypass circuit has an input connected to the battery power node and an output connected to the first battery pack to provide a first bypass signal path from the battery power node to the first battery pack that bypasses the first current delivery circuit for regenerative current from one or more of the motors; and the second bypass circuit has an input connected to the battery power node and an output connected to the second battery pack to provide a second bypass signal path from the battery power node to the second battery pack that bypasses the second current delivery circuit for regenerative current from one or more of the motors.

One example implementation further comprises flight electronics positioned on the aircraft body; a first voltage regulator that is configured to provide an output voltage to the flight electronics; and a surge protection circuit having an input connected to the battery power node and an output connected to the first voltage regulator, the surge protection circuit is configured to automatically prevent a surge of the regenerative current from one or more of the motors damaging the first voltage regulator. In one example implementation, the surge protection circuit includes a switch; and the surge protection circuit is configured to automatically reduce effective voltage of the regenerative current from one or more of the motors provided to the voltage regulator via the battery power node by opening and closing the switch multiple times during the regenerative current.

One example implementation further comprises a flight controller connected to the multiple bypass circuits, the flight controller is configured to determine that a regenerative event is occurring and turn on the multiple bypass circuits in response to determining that the regenerative event is occurring.

In one example implementation, the load balancing circuit is configured to draw power from a battery pack with a highest state of charge until more than one battery has a highest state of charge, when more than one battery has a highest state of charge then the load balancing circuit is configured to draw power from the more than one battery with the highest state of charge.

In one example implementation, the multiple motors are configured to create regenerative current in response to a braking action.

In one example implementation, each bypass circuit includes a switch.

In one example implementation, the multiple current delivery circuits each comprise a Schottky diode.

In one example implementation, the bypass circuits are configured to dump regenerative current from one or more of the motors in a battery pack not currently being used by the load balancing circuit to power the aircraft.

In one example implementation, the bypass circuits are configured to dump regenerative current from one or more of the motors concurrently into all battery packs.

One embodiment of an aircraft comprises: an aircraft body; a first battery pack positioned on the aircraft body; a second battery pack positioned on the aircraft body; a load balancing circuit positioned on the aircraft body, the load balancing circuit comprises a first current delivery circuit and a second current delivery circuit, the first current delivery circuit has an input connected to the first battery pack and an output connected to a battery power node, the second current delivery circuit has an input connected to the second battery pack and an output connected to the battery power node; multiple motors positioned on the aircraft body and connected to the battery power node; a first bypass circuit having an input connected to the battery power node and an output connected to the first battery pack to provide a first bypass signal path from the battery power node to the first battery pack that bypasses the first current delivery circuit for regenerative current from one or more of the motors; and a second bypass circuit has an input connected to the battery power node and an output connected to the second battery pack to provide a second bypass signal path from the battery power node to the second battery pack that bypasses the second current delivery circuit for regenerative current from one or more of the motors.

One example implementation further comprises a flight controller positioned on the aircraft body and connected to the bypass circuits, the flight controller is configured to open the bypass circuits when the motors are providing regenerative current and close the bypass circuits when the motors are not providing regenerative current.

In one example implementation, each battery pack includes multiple batteries in series and a battery management system.

One example implementation further comprises flight electronics positioned on the aircraft body; a first voltage regulator that is configured to provide an output voltage to the flight electronics; and a surge protection circuit having an input connected to the battery power node and an output connected to the first voltage regulator, the surge protection circuit is configured to prevent a surge of the regenerative current from one or more of the motors damaging the first voltage regulator.

In one example implementation, the surge protection circuit includes a switch, and the surge protection circuit is configured to automatically reduce effective voltage of the regenerative current from one or more of the motors provided to the voltage regulator via the battery power node by opening and closing the switch multiple times during the regenerative current.

One embodiment of a method comprises providing power to multiple motors positioned on an aircraft body from one or more of multiple battery packs positioned on the aircraft body via a load balancing circuit positioned on the aircraft body, the load balancing circuit comprises multiple current delivery circuits, each current delivery circuit is connected between one of the battery packs and a battery power node; causing the motors to generate a regenerative current; and providing a signal path for the regenerative current from the battery power node to one or more of the battery packs via one or more bypass circuits each of which is connected to the battery power node and one of the battery packs to provide a signal path from the battery power node to the respective battery pack that bypasses a respective current delivery circuit for the regenerative current from the motors.

One example implementation further comprises automatically reducing effective voltage of the regenerative current from the motors provided to a voltage regulator from the battery power node by opening and closing a switch between the voltage regulator and the battery power node multiple times during the regenerative current.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via one or more intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

1. An aircraft, comprising:
an aircraft body;
multiple battery packs positioned on the aircraft body;
a load balancing circuit positioned on the aircraft body, the load balancing circuit comprises multiple current delivery circuits, each current delivery circuit is connected between one of the battery packs and a battery power node;
multiple motors positioned on the aircraft body and connected to the battery power node; and
multiple bypass circuits each of which is connected to the battery power node and one of the battery packs to provide a signal path from the battery power node to the respective battery pack that bypasses a respective current delivery circuit for regenerative current from one or more of the motors.

2. The aircraft of claim 1, further comprising:
a flight controller positioned on the aircraft body and connected to the bypass circuits, the flight controller is configured to turn on the bypass circuits when the motors are providing regenerative current and turn off the bypass circuits when the motors are not providing regenerative current.

3. The aircraft of claim 1, wherein:
each battery pack includes multiple batteries in series and a battery management system.

4. The aircraft of claim 1, further comprising:
address translation circuits each of which is connected to one of the battery packs, each address translation circuit is configured to use the same address to communicate with its respective connected battery pack; and
a flight controller connected to the address translation circuits, the flight controller is configured to uses different addresses to communicate with different address translation circuits, the address translation circuits receive battery health data from respective connected battery packs and forward that battery health data to the flight controller.

5. The aircraft of claim 1, wherein:
the multiple battery packs include a first battery pack and a second battery pack;
the load balancing circuit comprises a first current delivery circuit and a second current delivery circuit;
the first current delivery circuit has an input connected to the first battery pack and an output connected to the battery power node;
the second current delivery circuit has an input connected to the second battery pack and an output connected to the battery power node;
the multiple bypass circuits comprise a first bypass circuit and a second bypass circuit;
the first bypass circuit has an input connected to the battery power node and an output connected to the first battery pack to provide a first bypass signal path from the battery power node to the first battery pack that bypasses the first current delivery circuit for regenerative current from one or more of the motors; and
the second bypass circuit has an input connected to the battery power node and an output connected to the second battery pack to provide a second bypass signal path from the battery power node to the second battery pack that bypasses the second current delivery circuit for regenerative current from one or more of the motors.

6. The aircraft of claim 1, further comprising:
flight electronics positioned on the aircraft body;
a first voltage regulator that is configured to provide an output voltage to the flight electronics; and
a surge protection circuit having an input connected to the battery power node and an output connected to the first voltage regulator, the surge protection circuit is configured to automatically prevent a surge of the regenerative current from one or more of the motors damaging the first voltage regulator.

7. The aircraft of claim 6, wherein:
the surge protection circuit includes a switch; and
the surge protection circuit is configured to automatically reduce effective voltage of the regenerative current from one or more of the motors provided to the voltage regulator via the battery power node by opening and closing the switch multiple times during the regenerative current.

8. The aircraft of claim 1, further comprising:
a flight controller connected to the multiple bypass circuits, the flight controller is configured to determine that a regenerative event is occurring and turn on the multiple bypass circuits in response to determining that the regenerative event is occurring.

9. The aircraft of claim 1, wherein:
the load balancing circuit is configured to draw power from a battery pack with a highest state of charge until more than one battery pack has a highest state of charge, when more than one battery pack has a highest state of charge then the load balancing circuit is configured to draw power from the more than one battery pack with the highest state of charge.

10. The aircraft of claim 1, wherein:
the multiple motors are configured to create regenerative current in response to a braking action.

11. The aircraft of claim 1, wherein:
each bypass circuit includes a switch.

12. The aircraft of claim 1, wherein:
the multiple current delivery circuits each comprise a Schottky diode.

13. The aircraft of claim 1, wherein:
the bypass circuits are configured to dump regenerative current from one or more of the motors in a battery pack not currently being used by the load balancing circuit to power the aircraft.

14. The aircraft of claim 1, wherein:
the bypass circuits are configured to dump regenerative current from one or more of the motors concurrently into all battery packs.

15. An aircraft, comprising:
an aircraft body;
a first battery pack positioned on the aircraft body;
a second battery pack positioned on the aircraft body;
a load balancing circuit positioned on the aircraft body, the load balancing circuit comprises a first current delivery circuit and a second current delivery circuit, the first current delivery circuit has an input connected to the first battery pack and an output connected to a battery power node, the second current delivery circuit has an input connected to the second battery pack and an output connected to the battery power node;
multiple motors positioned on the aircraft body and connected to the battery power node;
a first bypass circuit having an input connected to the battery power node and an output connected to the first battery pack to provide a first bypass signal path from the battery power node to the first battery pack that bypasses the first current delivery circuit for regenerative current from one or more of the motors; and
a second bypass circuit has an input connected to the battery power node and an output connected to the second battery pack to provide a second bypass signal path from the battery power node to the second battery pack that bypasses the second current delivery circuit for regenerative current from one or more of the motors.

16. The aircraft of claim 1, further comprising:
a flight controller positioned on the aircraft body and connected to the bypass circuits, the flight controller is configured to open the bypass circuits when the motors are providing regenerative current and close the bypass circuits when the motors are not providing regenerative current.

17. The aircraft of claim 1, wherein:
each battery pack includes multiple batteries in series and a battery management system.

18. The aircraft of claim 1, further comprising:
flight electronics positioned on the aircraft body;
a first voltage regulator that is configured to provide an output voltage to the flight electronics; and
a surge protection circuit having an input connected to the battery power node and an output connected to the first voltage regulator, the surge protection circuit is configured to prevent a surge of the regenerative current from one or more of the motors damaging the first voltage regulator.

19. The aircraft of claim 18, wherein:
the surge protection circuit includes a switch; and
the surge protection circuit is configured to automatically reduce effective voltage of the regenerative current from one or more of the motors provided to the voltage regulator via the battery power node by opening and closing the switch multiple times during the regenerative current.

20. A method, comprising:
providing power to multiple motors positioned on an aircraft body from one or more of multiple battery packs positioned on the aircraft body via a load balancing circuit positioned on the aircraft body, the load balancing circuit comprises multiple current delivery circuits, each current delivery circuit is connected between one of the battery packs and a battery power node;
causing the motors to generate a regenerative current;
providing a signal path for the regenerative current from the battery power node to one or more of the battery packs via one or more bypass circuits each of which is connected to the battery power node and one of the battery packs to provide a signal path from the battery power node to the respective battery pack that bypasses a respective current delivery circuit for the regenerative current from the motors.

21. The method of claim 20, further comprising:
automatically reducing effective voltage of the regenerative current from the motors provided to a voltage regulator from the battery power node by opening and closing a switch between the voltage regulator and the battery power node multiple times during the regenerative current.
